(19) United States
(12) Patent Application Publication
(10) Pub. No.: US 2010/0019426 A1
(43) Pub. Date: Jan. 28, 2010

(54) SPRING/SEAL ELEMENT

(75) Inventor: DALE IAN KUNZ, Calgary (CA)

Correspondence Address: BENNETT JONES LLP;C/O MS ROSEANN CALDWELL, 4500 BANKERS HALL EAST, 855 - 2ND STREET, SW, CALGARY, AB, T2P 4K7, CA

(73) Assignee: BJ TOOL SERVICES LTD., Calgary (CA)

(21) Appl. No.: 12/574,250

(22) Filed: Oct. 6, 2009

Related U.S. Application Data
(62) Division of application No. 11/676,193, filed on Feb. 16, 2007.
(60) Provisional application No. 60/774,712, filed on Feb. 17, 2006.

(51) Int. Cl. F16F 1/34

(52) U.S. Cl. 267/161

(57) ABSTRACT

The present invention relates to a spring element. The spring element includes a metal ring with a central aperture and radial pleats formed on the metal ring. The radial pleats flatten when pressure is applied axially to compress the ring such that the metal ring increases in effective diameter. The seal element may be used to radially seal an annular bore.

### CROSS REFERENCE TO RELATED APPLICATIONS

This is a divisional application of U.S. application Ser. No. 11/676,193 filed Feb. 16, 2007 and presently pending. U.S. application Ser. No. 11/676,193 claims priority under 35 U.S.C. §119(e) to U.S. provisional patent application No. 60/774,712 filed Feb. 17, 2006.

### FIELD OF THE INVENTION

The invention relates to an element having spring and sealing properties and in particular, a ring having spring and/or sealing properties and may radially expand upon being axially compressed, thereby increasing in diameter; but is resilient to return to its original form when the axial force of compression is removed.

### BACKGROUND OF THE INVENTION

In many industries, such as the oil and gas industry or in the mining industry, it is necessary to isolate producing fluids from the environment, or to isolate particular portions of a pipeline or a wellbore. Therefore, various seal elements have been developed for this purpose. Often these seals are elastomeric and have the ability to expand when pressure is applied, and to contract once the pressure is released. An example of an elastomeric seal is a “V-seal” in which “V”-shaped seal elements are stacked and energized by application of axial compression. Elastomeric elements are subject to wear and tear due to the high temperature and pressure environments in which they are employed. This could eventually lead to seal breakdown and consequently to well shut-down.

Within the context of petroleum drilling and completion systems, existing methods to provide hydraulic isolation (sealing) between portions of a wellbore or wellbore annulus—whether cased-hole or open-hole—are broadly described as packers or bridge plugs. Existing technology employs two types of seal element: 1) bulk expansion, or compression set and, 2) inflatable set.

A packer refers to a device providing annular closure, while a bridge plug specifically refers to a device providing full cross-sectional closure. Since closure of an annular space with respect to the device is always required, the term packer is employed here generally to all such devices.

In either case the device must provide sufficient annular clearance to first permit insertion into the wellbore to the desired depth or location, and a means to subsequently close this annular clearance to affect an adequate degree of sealing against a pressure differential. It is often also desirable to retract or remove these devices without milling or machining.

Devices relying on bulk expansion of the seal element typically employ largely incompressible but highly deformable materials, such as elastomers, as the sealing element or element “stack”, where the seal is cylindrically or toroidally shaped and carried on an inner mandrel. U.S. Pat. Nos. 5,819,846 and 4,573,537 are two examples of such devices using an elastomer and ductile metal (non-elastomeric), respectively, for the deformable seal element material. The seal is formed by imposing axial compressive displacement of the element causing the material to incompressibly expand radially (inward or outward or both) to close off either annular region, and after confinement is achieved, to apply sufficient pre-stress to promote sealing. The amount of annular expansion and sealing achievable with elastomers is dependent on several variables, but is generally limited by the extrusion gap allowed by the running clearance. The size of annular gap sealed with ductile metals is similarly limited, although for slightly different reasons, and since the deformation is largely irreversible, presents a further impediment to retrieval.

For either elastomers or ductile metals, practically achievable axial seal lengths are also short—in the order of a few inches—and therefore sealing on rough surfaces is not readily achievable. This limitation to sealing small clearances with relatively short seal lengths and limited conformability even for elastomers tends to preclude using this method for sealing against most open-hole wellbore surfaces. Furthermore, this style of device usually requires a means to react axial load (such as slips) that is separate from the sealing element. Such axial loads arise from pressure differentials acting on the sealed area, plus loads transmitted by attached or contacting members, and typically exceed the frictional or strength capacity of the seal material. This is especially true as the sealed area (hole diameter) is increased. Managing the setting and possible release of the associated anchoring systems adds considerable complexity to these devices, as well as associated cost and reliability implications. Similarly, the degree of complexity, cost and uncertainty is further increased where the application requires axial load reversal as arises when the pressure differential may be in either direction. Both the sealing and mechanical retaining hardware tends to require significant annular space; therefore, the maximum internal-bore diameter is significantly smaller than a setting diameter.

Devices relying on inflation of the membrane seal element employ a generally cylindrical sealing element (visualize a hose), capable of expanding radially outward when pressured the inside with a fluid, where the sealing element is carried on a mandrel with end-closure means to contain pressure and accommodate whatever axial displacement is required during inflation. The sealing element in these devices is typically of composite construction where an elastomer is reinforced by stiffer materials such as fibre strands, wire, cable, or metal strips (also commonly referred to as slats). U.S. Pat. No. 4,923,007 is one example of such a device employing axially aligned overlapping metal strips. Pressure containment by these elements relies largely on membrane action where the sealing element may be considerably longer and more conformable than in bulk-expansion devices. Inflation packers are therefore most commonly employed for sealing against the open-hole wellbore. The inflation materials may be a gas, liquid or setting such as cement slurry. Where the inflation material stays fluid, pressure must be continuously maintained to affect a seal. If the device develops a leak after inflating, the sealing function will be lost. To circumvent this weakness, a setting liquid such as cement is used; pressure need only be maintained until sufficient strength is reached. However, the device then becomes much more difficult to remove since it cannot be retracted through reverse flow of the inflation fluid. Typically, it can only be removed by machining or milling. Similar to the bulk expansion method, the membrane strength of these devices significantly limits the ability to react axial load and the annular space requirements of membrane end seals and mandrel can be quite large. Therefore inflatable packer elements tend to suffer from the same limited axial load and through bore capacities as bulk expansion packer elements.

### SUMMARY OF THE INVENTION

In accordance with a broad aspect of the invention, there is provided a spring element comprising: a metal ring including a central aperture therethrough; and radial pleats formed on the metal ring, wherein the radial pleats flatten when pressure is applied axially to compress the ring such that the metal ring increases in effective diameter.

In accordance with another broad aspect of the invention, there is provided a method of producing a spring element comprising: providing a ring element formed of sheet metal; mechanically forming the ring element in a manufacturing tool beyond its elastic limit to form radial pleats therein; and heat treating the metal ring element.

In accordance with another broad aspect of the invention, there is provided a seal for sealing radially in an annular bore comprising: a resilient ring including a body formed of metal and a plurality of radial pleats formed on the body, the ring having a spring force biasing the ring into a relaxed condition; at least one annular seal element proximal to the resilient ring, wherein the ring biases the annular resilient seal element to react with the spring force of the ring.

In accordance with another broad aspect of the invention, there is provided a seal assembly for use in a packer comprising: one or more annular seal elements; and one or more resilient rings including a body formed of metal; a plurality of radial pleats formed on the body; wherein the resilient rings interleave alternately with the annular seal elements.

It is to be understood that other aspects of the present invention will become readily apparent to those skilled in the art from the following detailed description, wherein various embodiments of the invention are shown and described by way of illustration. As will be realized, the invention is capable for other and different embodiments and its several details are capable of modification in various other respects, all without departing from the spirit and scope of the present invention. Accordingly the drawings and detailed description are to be regarded as illustrative in nature and not as restrictive.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a schematic view of a single pleated ring element;

FIG. 2a is a cross sectional view of a pleated ring embedded within an resilient ring inside a well system in an uncompressed state;

FIG. 2b is a cross sectional view of a pleated ring embedded within an resilient ring inside a well system when pressure is applied;

FIG. 3 is a cross sectional view of a pleated ring beneath a V-seal;

FIG. 4 is a schematic view of pleated ring stack in seal assembly in an open configuration;

FIG. 5 is a schematic view of pleated ring stack in seal assembly in a closed configuration.

### DETAILED DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

The present invention relates to a resilient metal element that can act as a seal and/or a spring, either alone or in conjunction with other resilient elements. The present invention is founded on the mechanical properties of resilient metal elements configured as pleated rings. The shape of each ring is such that it will flatten in thickness, as defined by pleat amplitude, and increase in diameter when axially compressed, and return to its original thickness and diameter when axial compression is relaxed.

The pleated ring can be used as a spring and/or a seal in a variety of applications, for example, where a spring force is required and/or wherein sealing is required. For example, the pleated ring can be used to decrease wear and tear of resilient elements, such as seals. The pleated ring also has several applications in the oil and gas industry where it can be used as a support for V-seals, in ring seals and inside packers. Due to the annular shape of the ring, the pleated ring may be particularly useful in an annulus.

The pleated metal ring has the characteristic of being reversibly deformable such that when pressure is applied axially to the pleated ring, the pleated ring can be compressed and expanded radially thereby increasing in diameter. When the pressure is reduced or released, the pleated ring seeks to return to its original shape, thereby increasing in thickness and decreasing in diameter. In addition, the resiliency of the pleated metal ring allows the ring to be compressed radially to reduce its effective diameter and increase its effective thickness (i.e. the amplitude of its peaks). Again, when radially compressive pressure is reduced or released, the pleated ring seeks to return to its original shape, thereby decreasing in thickness and increasing in diameter.

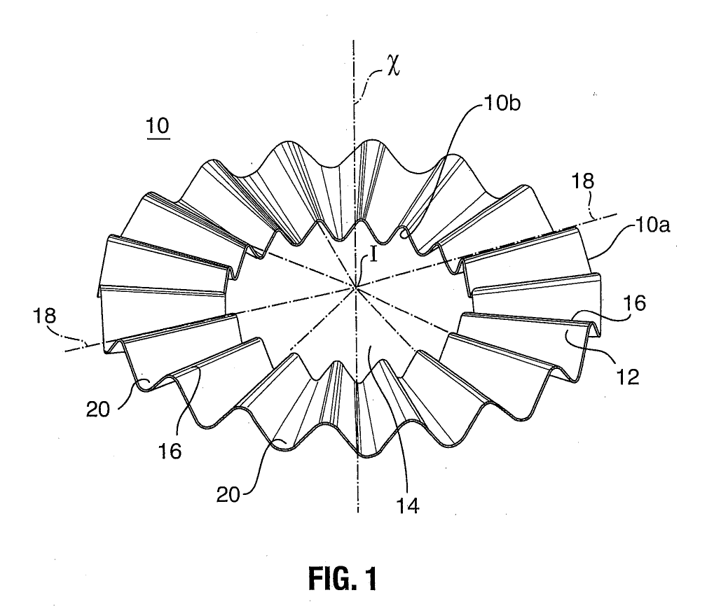

Referring to FIG. 1, a ring 10, as will be appreciated, includes an outer circumferential edge 10a and an inner aperture 14 defined by an inner edge 10b. Ring 10 includes a center axis x, about which the body of the ring extends. In the illustrated embodiment, edges 10a and 10b extend concentrically about axis x, but other configurations are possible. Of course, two surfaces of the ring are formed between edges 10a and 10b, one facing upwardly in FIG. 1 and the opposite surface facing downwardly in FIG. 1.

The ring may be radially pleated. For example, the ring may include pleats 12 having crests 16 extending from the inner edge 10a to the outer edge 10b of the ring as shown in FIG. 1. The lines 18 along the top of each crest may intersect at a point of intersection I in the aperture of the ring. The point of intersection may be positioned variously in the aperture, for example at the concentric center of the ring, at axis x, or off center. Crests 16 may form straight lines, or the lines of the crests may potentially be curved. As in a normal pleated configuration, the ring also has valleys 20 between crests 16. The pleated configuration of the ring is carried through both the upper surface and the lower surface of the ring, such that a crest on one surface forms a valley on the opposite surface and vice versa.

The ring crests 16 may extend in a single plane or in parallel planes, or alternatively, the lines of the crests may be slightly frustoconical. The at rest vertical height (i.e. amplitude) of the pleats 12 may vary from pleat to pleat and ring to ring depending on the application in which the ring is to be used, and the size of the aperture 14 and width of the ring from edge 10a to edge 10b may also vary. The ring may be made from thin sheet metal, the material selection and thickness of the ring being dependent on the application. Any material that has a high deformation to yield point may be used to construct the ring. For example, any material that can accept significant deformation before it reaches its elastic limit may be useful such as for example high ductility, low carbon steel (i.e. 60/40 carbon steel) or types of brass, bronze and stainless steel.

In one embodiment, the pleated ring elements may be formed from thin sheet steel in several steps:
1. The metal ring element may be stamped in a circular shape from thin sheet steel.
2. The element may be mechanically pleated in a tool that allows the angle of the pleat and the radius of the pleat curve to be adjusted. Pleating pushes the ring material beyond its elastic limit to plastically deform and set pleats therein. The pleating process has the effect of decreasing the effective, at rest circumference of the ring at edge 10b, decreasing the effective at rest outer diameter of the element and increasing its effective at rest vertical height.
3. After the shaping of the pleats, the steel elements may be heat treated to reduce the internal stress of bending the pleats, with the end-state Rockwell hardness ranging dependent on the application.

In one embodiment, the pleating tool includes an upper platen and a lower platen, each having teeth formed thereon that are positioned correspondingly between the platens to force pleats in the sheet metal ring positioned therebetween. The pleating tool further includes a press that forces the pleats together.

For example, the above-noted method was used to prepare a 7 inch ring with 18 pleats at an amplitude of approximately ⅝ inches, a plate thickness of 0.010 to 0.02 inches and made from 60/40 carbon steel.

Applications

Because of its resilient properties, a pleated ring can be used in various applications. For example, in one application, a ring may be useful in an application where pressure is to be applied axially to the ring and the ring's properties to be resiliently, axially compressed are of interest. Alternately, or in addition, the ring's properties to be resiliently, radially compressed are of interest. The ring form may be particularly useful in annular applications.

In various applications, rings such as ring 10 may be used in to drive radial expansion in response to axial compression to drive the ring or a seal element in association with the ring into contact with a cylindrical surface, with the intent that upon release of axial compressive force, the ring's retraction from the cylindrical surface may be of interest. In another embodiment, the resiliency of the ring to support the positioning or resiliency of other members may be of interest.

1) Inclusion in an Elastomeric Element

In one embodiment, for example, the metal ring element may be used to decrease wear and tear and increase the useful life of nonmetallic seals. The ring element may act as a spring to energize the nonmetallic seals and/or provide a bearing surface to protect against wear.

In one example, produced fluid generally exits from wells at very high temperatures and pressures. Under these circumstances, nonmetallic seals may mechanically degrade, leading to the need for more continual replacement and for the possibility of failure of the seal, both of which may require production shut down or costly well operations.

Examples of nonmetallic seals are elastomeric ring seals, some of which may be V-type seals being V- (or U-) shaped in cross-section. The nonmetallic seals may be made from various elastomeric materials. Often the nonmetallic seals are made of rubber or polymeric elastomers.

Ring seals may be selected to operate in various ways. For example, ring seals may be selected to provide annular seals by radial interaction against a cylindrical wall either through their inherent radial expansion properties or through radial expansion driven by axial compression. V-seals may include edge portions that a energized by axial forces applied mechanically or through pressure differentials. V-seals may be stacked such that an adjacent element, such as a backup ring applies axial load to the seal.

A pleated ring may be incorporated in, as by being attached to or inserted into, an elastomeric seal to impart additional resiliency to the seal when pressure is applied to the seal. For example, over time, as pressure is continually applied to the nonmetallic seal, the side, top or bottom surfaces of the nonmetallic seal may tend to degrade, leading to an inability to form a seal against the component being sealed or a seal may begin to loose its resiliency and may begin to plastically deform. When a pleated metal ring is incorporated in an elastomeric nonmetallic element, the ring may prolong the sealing properties of the elastomeric seal. For example, when pressure is applied, the pleated ring expands radially and, when pressure is removed, the pleated ring contracts. This energy may be transferred to the elastomeric material to increase the useful life and enhance the performance of the elastomeric seal over an elastomeric seal without a ring element.

The metal ring/elastomeric seal may be made with any size pleated metal ring. The metal ring may be secured to or embedded in whole or in part within the materials of the elastomeric seal. In one embodiment, the elastomeric material may be used to cover at least a portion of the metal ring, for example, to a thickness that allows the energy from the ring to be transferred throughout the elastomeric material.

The metal ring/elastomeric seal may be used in a well seal system for blocking fluid flow in a tubing string, for example. In this embodiment, the metal ring/elastomeric seal may be used to seal in an annular space between two tubing strings. The metal ring/elastomeric seal may used alone or with additional seals or structures to control the extrusion of the ring while it is expanded and retracted, and to prolong the life of the metal ring/elastomeric seal.

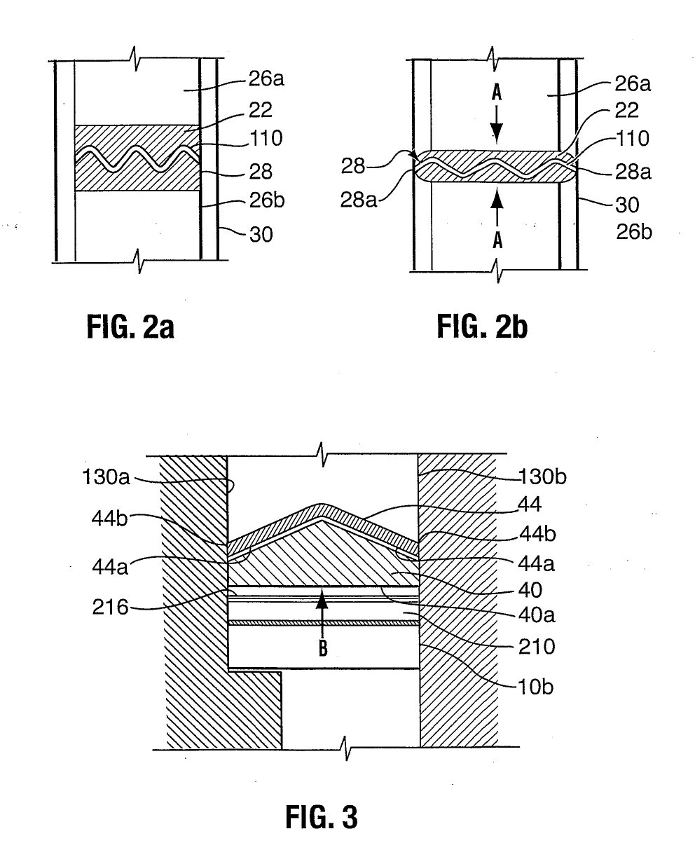

FIGS. 2a and 2b illustrate a metal ring/elastomeric seal in a well sealing system. In FIG. 2a, a pleated metal ring 110, generally as described with reference to ring 10 of FIG. 1, is embedded inside an extrudable elastomeric seal 22 to form a metal ring/elastomeric seal 28. In the illustrated embodiment, seal 28 may be used in a packer including upper and lower housings 26a, 26b, respectively, for use to seal an annular space between a wall 30 and the packer. When there is no pressure applied, the rings are not engaged against the wall of the annulus, so that fluid flow is unobstructed, as shown in FIG. 2a. When pressure shown by arrow A is applied in an axial direction by compression of the packer housings 26a, 26b against metal ring/elastomeric seal 28 as shown in FIG. 2b, ring 110 and seal 22 expand radially so that the outer edges 28a of the metal ring/elastomeric seal contact the inner surface of wall to seal the annulus.

In this embodiment, metal ring 110 acts to protect the material of seal 22 against damaging wear at outer edges 28a and metal ring 110 may also tend to urge the seal and elastomeric seal 22 to recover and return more readily to its original shape (FIG. 2a) when axial compressive pressure is removed.

2) V-Seal Application

Elastomeric V-seals are commonly used in annular applications such as between telescoping parts or being concentrically positioned tubular members, for example, in the oil and gas industry. In one embodiment, the pleated metal ring may be placed in proximity to the V-seals to act both to energize the seals, and to prolong the life of the seals.

Referring to FIG. 3, as will be appreciated, a V-seal 44 may be used in an annulus between a first wall 130a and a second wall 130b. A V-seal has a V-shaped cross section including a V- (or U-) shaped acutely angled surface 44a and a pair of sealing outer edges 44b. V-seal 44 may be energized by a back up ring 40 that is positioned to act against surface 44a and drive edges 44b out against walls 130a, 130b between which the seal is positioned to act.

In the illustrated embodiment according to the present invention, a pleated metal ring 210 may be positioned inside the annulus below back-up ring 40, so that the bottom surface 40a of the back-up ring makes contact with crests 216 of the pleated metal ring.

In such a configuration, as the edges 44b of the V-seal degrade over time due to wear or the high temperature or pressure of the environment, the metal ring continually acts as a spring to exert a force B to energizes the V-seal through back up ring 40, thereby extending the sealing life of the V-seal.

3) Debris Screen Application

In another embodiment, the radially expansive properties of a pleated metal ring may be employed to serve as a debris screen in an annular space. The pleated ring may be positioned in an annular space in a radially compressed configuration. In such a configuration, the ring is biased out by the force of the pleats therein such that it contacts the walls forming the annular space. In the extended state, the metal ring seals across the width of the annular bore, thereby preventing material such as debris from falling down the annular bore. As the ring wears at its inner and/or outer edges, it will continue to radially expand to fill the annular space.

4) Packer Application

In one embodiment, the metal ring elements may be interleaved alternately in a stack with sealing elements. These sealing elements may be elastomeric and in one embodiment may include a material selected to have elastomeric and friction reducing properties such as Teflon®. The arrangement may be used in a packer. The number of these elements used depends on the differential pressure that must be isolated in the application. It is anticipated that a simple low-pressure seal might employ a few metal rings with sealing elements therebetween. In one embodiment, 25 metal rings are employed in a stack with a Teflon® element between each adjacent pair of metal rings. A high-pressure seal might require 100 or more rings/sealing elements. If desired, the sealing elements may be pleated to substantially correspond to the shape of the rings.

The pleated, interleaved steel and Teflon® elements are nested in such a way that they will expand diametrically when they are compressed axially. When the stack is compressed the pleated ring elements expand radially until they contact the casing wall. Further compression creates a load against the casing wall, which may cause the ring edges 310a to form a leak-tight, metal-to metal seal. It is estimated that the interleaved steel and Teflon® elements may achieve diametrical outside-diameter expansion ratios of 1.2 to 1.4, or increase in diameter over 10% for example 20 to 40% and in one embodiment about 30% from the relaxed to compressed state.

When the compressive force is removed, the pleated elements return to their original shape, decreasing in diameter and retracting from the casing wall. As the stack increases in vertical height, it extracts the sealing sleeve from the inside diameter of the spring steel elements, allowing it to shrink back to its original diameter. The compressive force applied axially on the stack of elements may be any compressive force employed in mechanical packers. This may include the weight of tubing string, hydraulic action, or mechanical force generated by rotating a threaded element.

The Teflon® elements may be selected based on the temperature of the application. They may be formed as rings and may be stamped in the same fashion as the metal rings, out of thin sheet material. The Teflon® elements may be freely positioned between adjacent metal rings or may be mounted on one or both sides of pleated metal rings, for example.

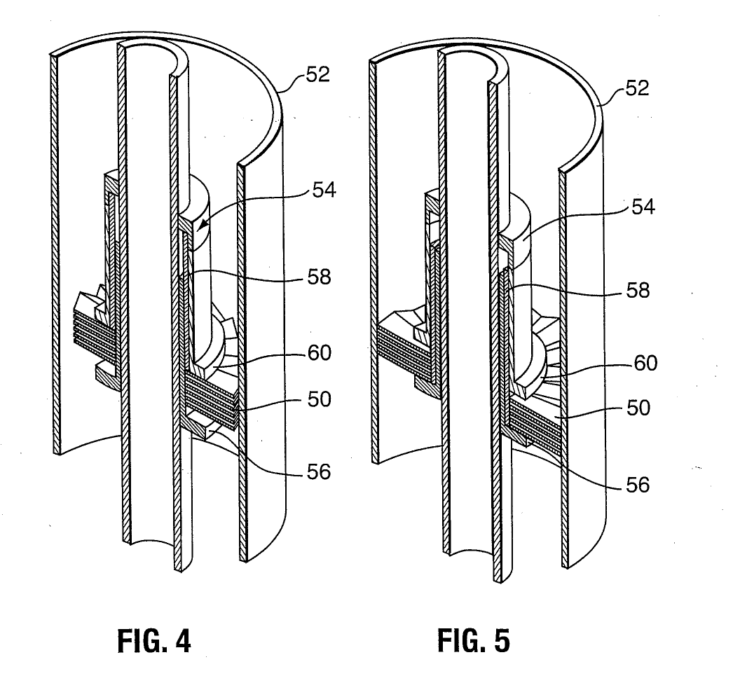

Referring to FIG. 4, the stack of pleated rings and Teflon® elements 50 may be contained within a seal assembly 52, which also contains a compression collar 54 to apply axial loading to the stack to compact it. Other components of the seal assembly may include an inner compression sleeve 56, which provides a metal-to metal seal between the carrier and the spring steel element; a sealing sleeve 58, which forms a leak-tight seal with a spacer mandrel, for example; and an outer compression sleeve 60, which transfers force from the compression collar to the spring steel elements and causes them to expand in a radial direction as they are flattened, as shown in FIG. 5.

The interleaved pleated rings may be stacked to the thickness required and then installed on a packer chassis. The seal assembly may be formed of telescoping cylindrical elements that will provide for the compression of the pleated rings, the forcing of a seal sleeve into the annular space between the expanded inner diameter of the seal stack, and the sealing of the seal sleeve at top and bottom. The seal carrier may be assembled and installed on a packer mandrel as one assembly.

The seal element, comprising the stack of pleated rings interleaved with sealing elements of, for example, Teflon, may be installed in any existing bulk displacement mechanical packer such as with an operating range of 25,000 pounds of force or greater. The seal element may be installed as a direct replacement for the bulk displacement rubber or resilient or elastomeric element(s). It may be installed as one-piece replacement, sliding onto the polished packer mandrel in the same way that the bulk displacement elements are installed.

The seal element can be designed so that the components can be changed to suit the application. For example, the metal elements can be corrosion-resistant for high H₂S or CO₂ environments. The Teflon® elements can be chosen to service low or high temperature environments, and for a variety of production fluids. As such, the seal can be used in a wide range of applications from permanent installations in thermally stimulated wells, to multiple-use applications such as well-servicing jobs where it is run as a temporary tool on conventional tubing or wireline, for example. Additionally, the seal can be used as a permanently installed downhole annular safety-shut-off valve where flow is controlled by the open and closing action of the device.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. A spring element comprising:
a metal ring including a central aperture therethrough; and
radial pleats formed on the metal ring wherein the radial pleats flatten when pressure is applied axially to compress the ring such that the metal ring increases in effective diameter.

2. The metal ring of claim 1 wherein the pleated metal ring is comprised of a metal with a high deformation to yield point.

3. The metal ring of claim 1 which is used to seal an annulus.

4. The metal ring of claim 1 wherein the radial pleats have crests extending from the inner edge to the outer edge of the pleated metal ring.

5. The metal ring of claim 1 wherein the pleated metal ring is comprised of 60/40 carbon steel.
